(19) United States
(12) Patent Application Publication
(10) Pub. No.: US 2026/0027804 A1
(43) Pub. Date: Jan. 29, 2026

(54) SELF-ADHESIVE VAPOR WRAP

(71) Applicant: Protecto Wrap Company, Denver, CO (US)

(72) Inventor: John R. Hopkins, II, Bow Mar, CO (US)

(21) Appl. No.: 19/275,006

(22) Filed: Jul. 21, 2025

Related U.S. Application Data
(60) Provisional application No. 63/674,897, filed on Jul. 24, 2024.

(51) Int. Cl. B32B 7/14; B32B 5/02; B32B 7/06; B32B 27/12; B32B 27/32

(52) U.S. Cl. CPC B32B 7/14; B32B 5/022; B32B 7/06; B32B 27/12; B32B 27/32; B32B 2305/026; B32B 2307/724

(57) ABSTRACT

A self-adhesive vapor permeable membrane having a porous sheet layer. Formed onto one surface of the porous sheet layer are a plurality of individual adhesive lines. The individual adhesive lines are spaced across the width of the porous sheet layer and extent along the length of the porous sheet layer. Portions of the porous sheet layer between the individual adhesive lines remain free of adhesive.

### CROSS REFERENCE

The present application claims the benefit of the filing date of U.S. Provisional Application No. 63/674,897 having a filing date of Jul. 24, 2024, the entire contents of which are incorporated herein by reference.

### FIELD

The present disclosure relates to a self-adhering air and moisture barrier membrane for structural surfaces of buildings. The membrane is permeable to the passage of water vapor and includes. A plurality of spaced adhesive lines are applied to one surface of the membrane for use in adhering the membrane to a structural surface.

### BACKGROUND

Many buildings are constructed with exterior wood, cement, concrete masonry unit walls or gypsum-based sheets that are overlaid with a cladding system or exterior weathering system (e.g., wood, cement, metal, masonry, vinyl sidings, asphalt shingles, or tile). When such a building is under construction, in many cases, a flexible sheeting material (e.g., Tyvek® from DuPont) is nailed or stapled to the construction sheathing before the cladding is mounted. Such sheeting material provides some protection while the building is under construction, as well as after the siding is mounted. Such protection includes a resistance against wind and liquid water penetration.

Barrier membrane sheet materials used on new construction are designed to control the flow of moisture in and out of the building. Such products are designed to be weather resistant, keeping out liquid water and resisting wind pressure. However, it is desirable that the barrier membrane be formed so that water vapor may pass through relatively freely to avoid problems of dampness or condensation within a building or within a wall or roof structure. Such barrier membranes have typically been attached to structures using mechanical fasteners (e.g., staples) or liquid adhesives/primers. Mechanical fasteners have the disadvantage of forming punctures in the barrier membrane as well as providing poor contact between the barrier membrane and the building structure. This can allow moisture to migrate beneath the membrane without passing through the membrane. Liquid adhesives tend to significantly reduce the permeability of the barrier membrane.

Self-adhesive vapor permeable barrier membranes (peel and stick) have been produced. However, such self-adhesive membranes tend to have limited permeability in areas covered by adhesive.

### BRIEF DESCRIPTION OF THE DRAWINGS

FIG. 1 illustrates a self-adhesive vapor permeable membrane with a release sheet partially removed.

FIG. 2 illustrates the self-adhesive vapor permeable membrane if FIG. 1 with the release sheet removed.

FIG. 3 illustrates a partial cross-section of the self-adhesive vapor permeable membrane of FIG. 2.

FIG. 4 illustrates a slot die extrusion system for applying adhesive to a vapor permeable membrane.

FIG. 5 illustrates a die for use with a slot die extrusion machine to form a plurality of parallel adhesive lines on a vapor permeable membrane.

### DETAILED DESCRIPTION

Reference will now be made to the accompanying drawings, which at least assist in illustrating the various pertinent features of the presented disclosure. The following description is presented for purposes of illustration and description and is not intended to limit the disclosed embodiments to the forms disclosed herein. Consequently, variations and modifications commensurate with the following teachings, and skill and knowledge of the relevant art, are within the scope of the presented embodiment(s). The embodiments described herein are further intended to explain the best modes known of practicing the inventions and to enable others skilled in the art to utilize the inventions in such, or other embodiments and with various modifications required by the particular application(s) or use(s) of the presented disclosure.

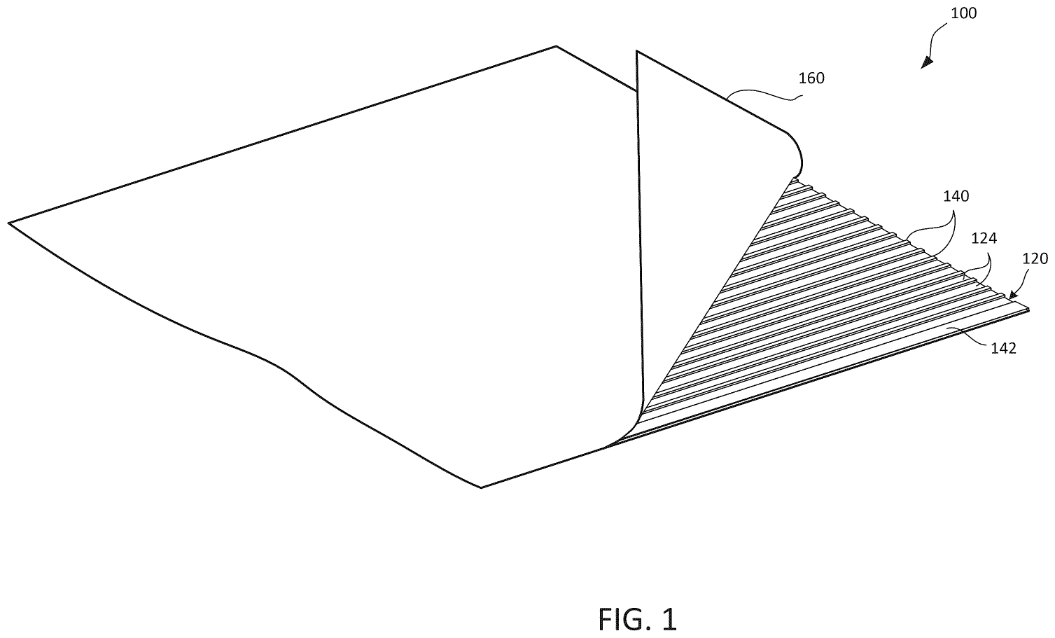

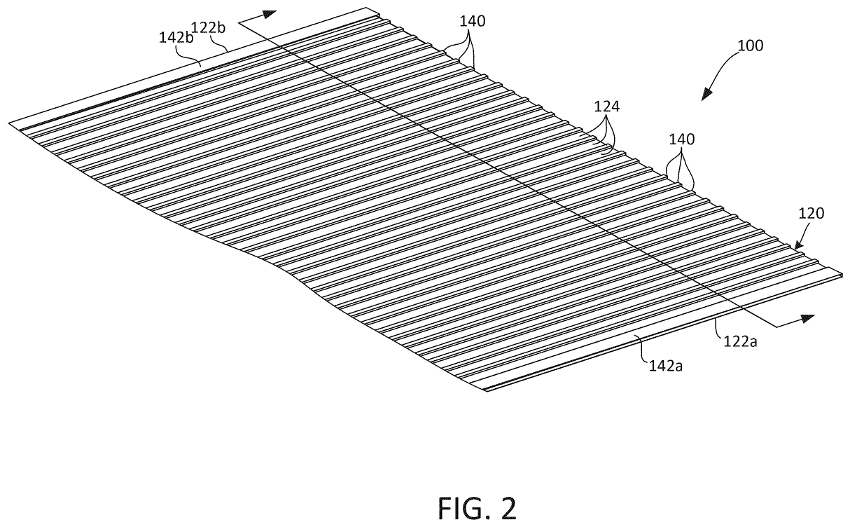

FIGS. 1 and 2 illustrate one non-limiting embodiment of a self-adhesive vapor permeable membrane 100 in accordance with the present disclosure. The membrane 100 includes a porous sheet layer 120, a plurality of spaced adhesive lines 140 disposed on a surface of the porous sheet layer 120 and, prior to removal, a release sheet 160 that releasably covers the plurality of spaced adhesive lines 140 prior to application of the membrane to a structural surface. As illustrated in FIG. 1, the release sheet 160 is partially removed to expose a portion of the underlying porous sheet layer 120 and a portion of the plurality of spaced adhesive lines 140. FIG. 2 illustrates the membrane with the release sheet fully removed.

In an embodiment, the porous sheet layer 120 is supplied in roll form and the adhesive lines 140 may be formed continuously along a length of the sheet layer 120 (e.g., on one surface or face of the sheet layer) while being spaced across a width of the sheet layer 120 between a first edge 122a and a second edge 122b. See FIG. 2. Once the plurality of adhesive lines 140 are formed on the sheet layer 120 and covered by the release sheet 160, the membrane 100 may be rolled to form a product roll (not shown). In a non-limiting embodiment, the sheet layer 120 of such a product roll may be approximately 40 inches wide and 120 feet long. Other dimensions are possible and within the scope of the present disclosure.

The porous sheet layer 120, in an embodiment, incorporates microporous film/sheet technology and includes small pores that allow diffusion of water molecules, driven by vapor pressure differential, from one side of the sheet to the other (e.g., from inside a structure to outside of the structure, when applied). Sheet materials that allow passage of water vapor while restricting air passage are generally referred to as vapor permeable barriers. The sheet or film may be microporous, microperforated or some other type of vapor permeable sheet or film. In some embodiments, a sheet material that allows passage of both air and water vapor may be utilized. In the illustrated embodiment, the porous sheet layer 120 is a vapor permeable sheet that is microporous, microperforated or otherwise vapor permeable. Some non-limiting examples of microporous sheets of films include spunbonded or fibrous bonded polyolefins (e.g., polyethylenes and polypropylenes). Other suitable microporous materials include oriented polymeric films. The porous sheet material may be reinforced with one or more adjacent sheet materials such non-woven polypropylene or non-woven polyester for the purpose of improving strength and other physical properties. In one embodiment, the sheet material is a self-sealing, nonwoven, vapor permeable microporous polyolefin laminate. In any embodiment, the porous sheet layer 120 will have a thickness between about 5 mils and about 50 mils. Further, the porous sheet layer will have a minimum permeability rating (i.e., prior to adhesive line coverage) of at least 10 Perms, where a Perm is defined as 1 grain of water vapor per hour, per square foot, per inch of mercury or as 1 gram of water vapor per day, per square meter, per millimeter of mercury. More commonly, the porous sheet layer will have a permeability exceeding 20 Perms, exceeding 30 Perms, exceeding 40 Perms and/or exceeding 50 Perms.

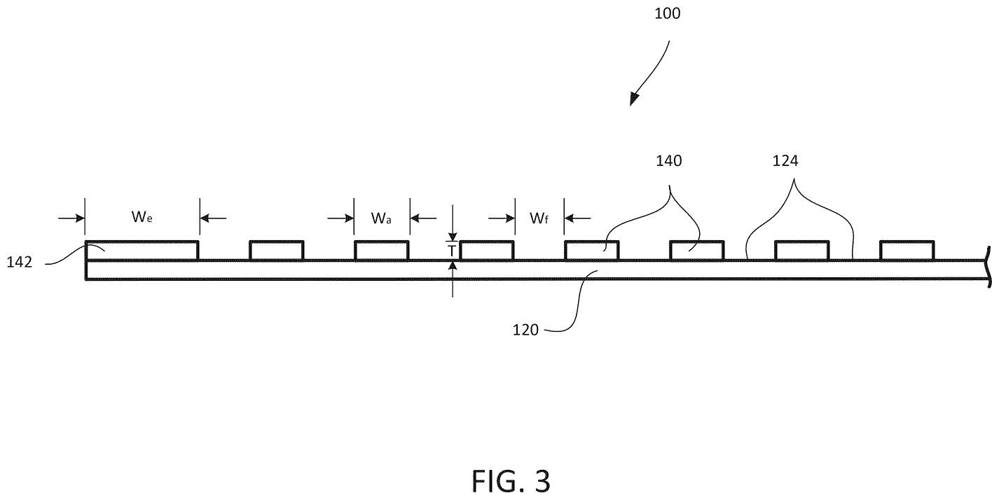

As illustrated in FIG. 3 (not to scale), the plurality of adhesive lines 140 are spaced across the surface of the porous sheet layer 120. The adhesive lines are formed substantially parallel along the surface of the sheet layer 120 (See also FIG. 2) and areas of the sheet layer 120 between adjacent adhesive lines 140 remain free of adhesive. Accordingly, permeability of the uncoated areas of the sheet layer 120 remain unaffected by the adhesive coverage. The width of the adhesive lines “Wₐ” and the width of the uncovered portions 124 of the sheet layer free of adhesive “W_{f}” may be varied. In an embodiment, the width Wₐ of the adhesive lines is between about 2 mm (e.g., 78 mils) and about 2 cm (e.g., 788 mils). The width of the adhesive fee portions 124 of the adhesive sheet W_{f} may likewise be between about 2 mm (e.g., 78 mils) and about 2 cm (e.g., 788 mils). In an embodiment, the adhesive width Wₐ and the uncovered portions width W_{f} may be equal. In such an embodiment, approximately one-half (e.g., 50%) of a surface area of the sheet layer 120 remains free of adhesive allowing this portion of the sheet layer 120 to permit vapor transmission free of impediment by the overlying adhesive lines 140. That is, the permeability of the uncovered portions of the sheet layer are unaffected by the adhesive while covered portions may have a reduced permeability. However, an average permeability of the membrane is typically greater than a membrane with a continuous adhesive layer. Further, the generally parallel lines of the adhesive lines provide channels between the porous sheet layer and underlying structure (e.g., when the membrane is applied to the structure) through which water and vapor can migrate along the length of the membrane exposing the water and vapor to more surface area of the permeable sheet layer. While permitting some migration along the length of the member, any water or vapor in the channels remains in close proximity to the porous sheet layer due to adjacent adhesive lines holding the porous sheet layer in contact with the underlying structure. Accordingly, any water or vapor in the channels eventually contacts and passes through the porous sheet layer.

While these widths Wₐ and W_{f} may be equal, this is not a requirement. In various embodiments, the adhesive lines 140 may cover between 25% and 75% of the surface area of the sheet layer 120. Inversely, between 75% and 25% of the surface area of the sheet layer may remain free of adhesive. The thickness “Tₐ” of the adhesive may also be varied. The thickness Tₐ may vary between about 1 mil and about 25 mils. In a more specific embodiment, the thickness Tₐ may vary between about 6 mils and about 15 mils. In a further embodiment, the thickness Tₐ may vary between about 10 mils and about 12 mils. It has been recognized that having a thickness Tₐ of at least 8 mils provides an adhesive line 140 that will conform to irregularities of an underlying surface (e.g., oriented strand board/OSB) providing significantly improved adherence between the membrane 100 and an underlying structure. That is, a thickness Tₐ of at least 8 mils provides enough deflection when applied to accommodate surface irregularities.

FIGS. 2 and 3 illustrate another, optional, feature of the membrane 100. As shown, the edge adhesive lines 142a, 142b (hereafter 142 unless specifically references) formed along the edges 122a, 122b of the sheet layer 120 have a width Wₑ that is significantly wider that the width Wₐ of the plurality of adhesive lines 140 disposed between the edge adhesive lines 142. It has been found that, during application of the membrane to structures, if the edges 122a, 122b lack a wider adhesive line, the membrane is susceptible to debonding from the structure in windy conditions (i.e., before siding is applied over the membrane). The increased width Wₑ of the edge lines 142 provides enough adherence to an underlying structure to significantly reduce or eliminate such debonding. In an embodiment, the Wₑ of the edge adhesive lines 142 is at least twice the width Wₐ of the central adhesive lines 140. In various embodiments, the edge adhesive lines 142 have a width between about 4 mm (e.g., 156 mils) and about 6 cm (e.g., 2360 mils). In other embodiments (not shown), a single edge of the membrane 100 may include a wider edge adhesive line.

The adhesive lines 140 and, if present 142 may be formed from a variety of adhesives. For instance, the adhesive can be a hot melt adhesive, solvent based adhesive, water based adhesive or of other types such as UV cured polymer. The applied adhesive is preferably tacky, i.e.—sticky and pressure sensitive. Suitable hot melt adhesives may contain such ingredients as polymers such as butyl rubber, styrene-butadiene-styrene (SBS), styrene-isoprene-styrene (SIS), styrene butadiene (SB), styrene-ethylene-butadiene-styrene (SEBS) and ethylenevinylacetate (EVA); resins such as those of the hydrocarbon and rosin types, natural and petroleum waxes, oils, bitumen and others. Solvent-based adhesives may contain ingredients such as those listed above, dissolved or dispersed in a solvent vehicle. Water based adhesives would normally be based on emulsions of polymeric materials. Suitable polymeric materials would include vinyl acetate and acrylic polymers and copolymers such as vinyl acetate acrylic, ethylene vinyl acetate as well as styrene acrylic, vinyl chloride acrylic, vinyl versatate and others. From a production standpoint, the preferred adhesives are of the hot melt type which are melted for application and as discussed below, applied in a slot die extrusion process. In one embodiment, the adhesive is a synthetic butyl adhesive. In such an embodiment, the synthetic butyl adhesive has significantly improved characteristics. In particular, the synthetic butyl adhesive allows for installation of the membrane in temperatures between about −20° F. (−28° C.) and 125° F. (51.6° C.). Further, the membrane can be applied to damp surfaces and can be applied without a primer on most surfaces.

When the adhesive lines 140, and if present 142, are applied to the sheet layer 120, the adhesive may be covered by a strippable release sheet 160. The strippable release sheet or liner 160 allows the membrane to be rolled to enable packaging in rolls. Suitable release sheets are paper sheet, having a silicone release surface coating and some treated plastic films.

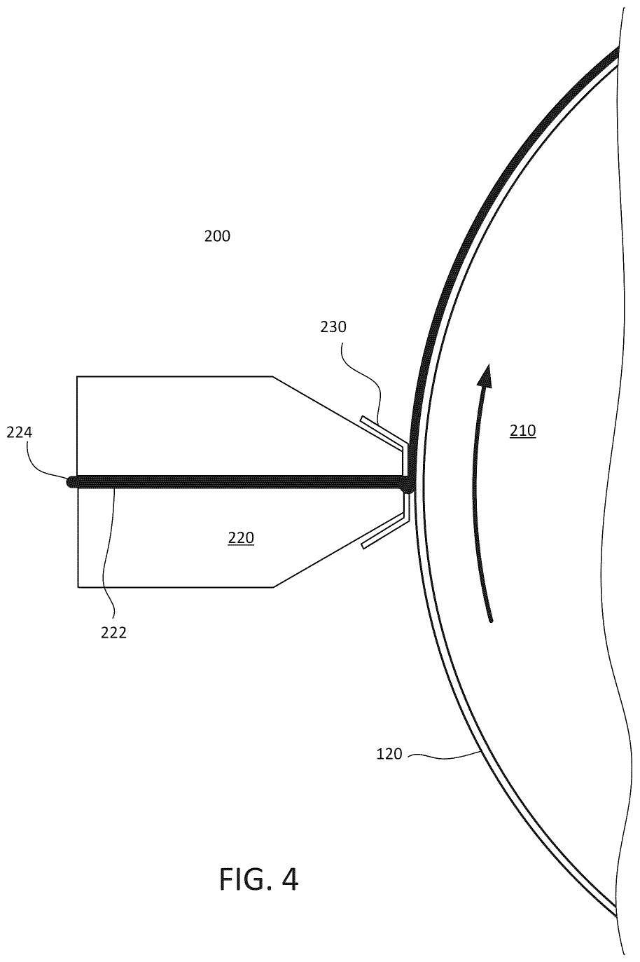

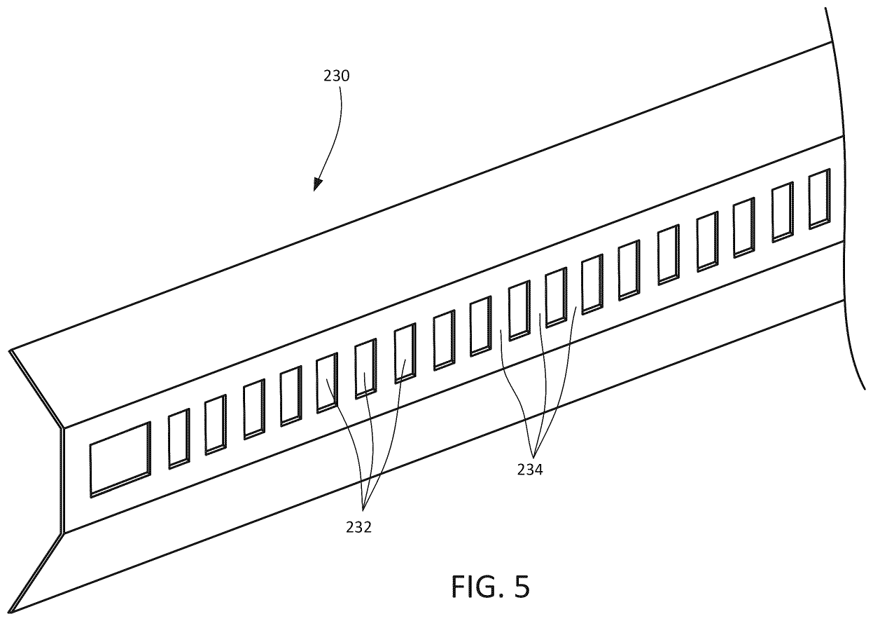

FIG. 4 illustrates a cross-sectional sideview of an exemplary slot die extrusion apparatus 200 that is used to apply the adhesive lines 140 (and if present 142) to the sheet layer 120. As shown, the apparatus incudes a rotating drum 210. The sheet layer 120 is tensioned about a portion of the rotating drum 210. An extrusion die 220 is positioned a predetermined distance from the outer surface of the sheet layer 120. The predetermined distance from an outlet end of the die 220 to the sheet layer 120 may be selected to form adhesive lines of a desired thickness. As shown, a die plate 230 is attached to the outlet end of the extrusion die 220. As illustrated in FIG. 5, the extrusion die 230 includes a plurality of apertures 232 spaced along its length. These apertures are separated by solid sections 234. The width of the apertures and the width of the solid sections are formed to control the adhesive width Wₐ and the uncovered portions width W_{f} of as formed on the sheet layer 120.

In operation, the drum 210 rotates at a predetermined speed while melted adhesive 224 is forced through an internal passage 224 in the extrusion die 220. The melted adhesive 224 passes through the separated apertures 232 in the die plate 230 and contacts the outer surface of the sheet layer 120. This forms individual spaced adhesive lines, which are substantially parallel, on the surface of the sheet layer 120. In an embodiment, the drum 210 is actively cooled (e.g., via water or refrigerants) such that the melted adhesive 224 at least partially congeals on the surface of the sheet layer 120. After application of the adhesive lines 140 and, if present, 142, a release sheet may be applied to the adhesive lines 140/142.

EXAMPLE—A vapor permeable membrane was formed in a slot die extrusion process. The sheet layer was formed form a nonwoven, vapor permeable microporous polyolefin laminate. The adhesive lines were formed from a synthetic butyl adhesive. The adhesive lines had a width of approximately 3 mm with a spacing of approximately 2 mm. The overall thickness of the membrane was 27 mills with the adhesive. The adhesive had a thickness of 10-12 mils. The resulting membrane had a perm rating of 43.5 perms according to standard ASTM E 96A. The resulting membrane had an installation range of between −20° F. (−28° C.) and 125° F. (51.6° C.).

All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure. As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, which is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A self-adhesive vapor permeable membrane, comprising:
a porous sheet layer having a width extending between and first edge and a second edge;
a plurality of individual adhesive lines formed on a surface and along a length of the porous sheet layer, wherein the lines are spaced from one another across the width of the porous sheet layer and wherein portions of the sheet layer between any two adjacent adhesive lines are free of adhesive.

2. The membrane of claim 1, further comprising:
a removable release sheet applied over the plurality of individual adhesive lines.

3. The membrane of claim 1, wherein at least a portion of the adhesive lines have an equal width and are equally spaced across the width of the porous sheet layer.

4. The membrane of claim 1, wherein a portion of the porous sheet layer covered by the individual adhesive lines is substantially equal to a portion of the sheet layer free of the individual adhesive lines.

5. The membrane of claim, wherein a portion of the porous sheet layer covered by the individual adhesive lines is greater than a portion of the sheet layer free of the individual adhesive lines.

6. The membrane of claim 1 a portion of the porous sheet layer covered by the individual adhesive lines is less than a portion of the sheet layer free of the individual adhesive lines.

7. The membrane of claim 1, wherein the adhesive lines cover between 25% and 75% of the surface of the porous sheet layer.

8. The membrane of claim 1, wherein the adhesive lines cover between 40% and 60% of the surface of the porous sheet layer.

9. The membrane of claim 1, wherein a width of the individual adhesive lines is between about 2 mm and about 2 cm.

10. The membrane of claim 1, wherein a width of portions of the sheet layer between adjacent adhesive lines and free of adhesive is between about 2 mm and about 2 cm.

11. The membrane of claim 1, wherein at least one edge adhesive line along at least one edge of the porous sheet layer has a width that is greater than the width of the individual adhesive lines disposed between the edges of the porous sheet layer.

12. The membrane of claim 11, wherein a width of the at least one edge adhesive line is at least twice the width of the individual adhesive lines disposed between the edges of the porous sheet layer.

13. The membrane of claim 1, wherein the porous sheet layer is a non-woven layer.

14. The membrane of claim 1, wherein the porous sheet layer is a polyolefin laminate.

15. The membrane of claim 1, wherein an adhesive forming the adhesive lines is a synthetic butyl adhesive.

16. The membrane of claim 1, wherein the membrane has a Perm rating of at least 30.

17. The membrane of claim 1, wherein the membrane has a Perm rating of at least 40.

18. A method of producing the membrane:
slot die extruding a hot melt adhesive through a die plate having a plurality of spaced apertures onto a surface of the porous sheet layer while the porous sheet layer is moving to form a plurality of individual adhesive lines along a length of the porous sheet layer.

19. The method of claim 18, further comprising:
rotating a portion of the sheet layer around a portion of a drum.

20. The method of claim 19, further comprising:
cooling the drum to at least partially congeal the plurality of individual adhesive lines.
